(19) United States
(12) Patent Application Publication
(10) Pub. No.: US 2025/0389212 A1
(43) Pub. Date: Dec. 25, 2025

(54) APPLICATOR FOR SEMI-FLUID MATERIALS

(71) Applicant: INNIO Waukesha Gas Engines Inc., Waukesha, WI (US)

(72) Inventor: Todd Mitchell, Ontario (CA)

(21) Appl. No.: 19/111,766

(22) PCT Filed: Jan. 19, 2023
(86) PCT No.: PCT/US2023/011166

§ 371 Date: Mar. 13, 2025

(30) Foreign Application Priority Data
Sep. 14, 2022 (CA) 3173995

(51) Int. Cl. F01L 3/04; F01L 3/08

(52) U.S. Cl. CPC F01L 3/04; F01L 3/08

(57) ABSTRACT

An applicator is positionable within a valve seat bore of an engine and includes a body portion. A sealing portion extends radially outwardly from the body portion for sealing abutment with the bore. A wiper portion extends radially outwardly from the body portion and narrower in diameter than the sealing portion. A circumferential groove may be between the sealing portion and the wiper portion and recessed relative to the wiper portion. A seat extends radially inwardly from the wiper portion for sealing cooperation with a first reduced-diameter wall portion of the bore. A conduit extends through the body portion and the sealing portion to the circumferential groove. A sealant-receiving cavity extending circumferentially about the circumferential groove may be defined between the sealing portion, the seat and a wall of the bore when the applicator is positioned within the bore.

### TECHNICAL FIELD

The present disclosure generally relates to application of semi-fluid materials to surfaces and particularly to application of sealant to inner surfaces of a valve seat bore prior to installation of valve seats in an engine.

### BACKGROUND

The valve seat in an internal combustion engine is the surface against which an intake or an exhaust valve rests during the portion of the engine operating cycle when that valve is closed. The valve seat maintains the airtightness of the combustion chamber to provide a favorable compression ratio and thereby efficient engine performance.

The valve seat is positioned within a machined valve seat bore. Sealant is applied to the valve seat bore prior to installation of the valve seat within the valve seat bore therein. The sealant must be applied only to certain areas requiring coverage. The sealant must be applied evenly and any excess sealant must be removed.

Sealants used are typically semi-fluid because they can be applied to the necessary surfaces without runoff. Semi-fluid sealants are typically applied from a syringe-type device. A conventional method for applying sealant to the desired surfaces is to apply one or more beads of the sealant to the desired surface directly using the syringe. The bead is then evenly distributed and smoothed by a person using their finger or another spreading device functioning in a similar manner. This method has a number of shortcomings. Direct application of sealant to the surface is inconsistent and often results in unnecessary amounts of sealant being used. Any excess sealant is removed and discarded, thereby resulting in wasted material. Spreading the sealant manually using a person's finger is also inconsistent and the spreading of the sealant results in sealant being pushed onto surfaces where no sealant is desired. That runover sealant must then be removed, thereby prolonging the step of applying sealant to the valve seat bore resulting in wasted time. Moreover, the machined surfaces of the valve seat bore may have sharp edges which can cause injury to a person's finger as it is moved over the surface.

It is therefore desirable to have a means of applying sealant to a valve seat bore which applies sealant evenly and consistently to the desired surfaces and which avoids excessive application of sealant and hence also avoids wasted time and materials.

### SUMMARY

The present disclosure generally relates to application of semi-fluid materials to surfaces and particularly to application of sealant to inner surfaces of a valve seat bore prior to installation of valve seats in an engine.

In a first aspect, there is provided an applicator positionable within a valve seat bore of an engine. The applicator includes a body portion. A sealing portion extends radially outwardly from the body portion for sealing abutment with the valve seat bore. A wiper portion extends radially outwardly from the body portion and narrower in diameter than the sealing portion. A circumferential groove may be between the sealing portion and the wiper portion and recessed relative to the wiper portion. A seat extends radially inwardly from the wiper portion for sealing cooperation with a first reduced-diameter wall portion of the valve seat bore. A conduit extends through the body portion and the sealing portion to the circumferential groove. At least one outlet extends from the conduit to the circumferential groove. A sealant-receiving cavity extending circumferentially about the circumferential groove may be defined between the sealing portion, the seat and a wall of the valve seat bore when the applicator is positioned within the valve seat bore. The conduit may extend along a longitudinal axis of the body portion. The at least one outlet may include a plurality of outlets.

In one aspect, the first reduced-diameter wall portion of the valve seat bore is a first ledge which is received by the seat when the applicator is positioned within the valve seat bore.

In another aspect, the applicator further includes a second body portion extending axially away from the wiper portion, the second body portion having a reduced-diameter end portion opposite the wiper portion for sealing cooperation with a second reduced-diameter wall portion of the valve seat bore. The second body portion may be receivable within the valve seat bore in sealing cooperation therewith. A second wiper portion may extend radially outwardly from the second body portion and narrower in diameter than the second sealing portion. A second circumferential groove may be between the second sealing portion and the second wiper portion and recessed relative to the second wiper portion, wherein the conduit extends continuously through the body portion, the circumferential groove and the second body portion to the second circumferential groove. A second seat may extend radially inwardly from the second wiper portion for sealing cooperation with the bore. At least one second outlet may extend from the conduit to the second circumferential groove. A sealant-receiving cavity extending circumferentially about the second circumferential groove may be defined between the second sealing portion, the second seat and a wall of the bore when the applicator is positioned within the bore. In this aspect, the at least one outlet may include a plurality of outlets and the at least one second outlet may include a plurality of second outlets.

In one aspect, the first reduced-diameter wall portion of the valve seat bore is a first ledge which is received by the seat and the second reduced-diameter wall portion of the valve seat bore is a second ledge narrower than the first ledge which cooperates in sealing abutment with the reduced-diameter end portion of the second body portion when the applicator is positioned within the valve seat bore.

In another aspect, a base portion may extend axially away from the second seat for being received in sealing cooperation within the valve seat bore when the applicator is positioned within the valve seat bore.

A handle portion may extend from the body portion. A plurality of petaloid projections may extend radially outwardly from the handle portion. The conduit may extend through the handle portion. A syringe body receiving portion may be continuous with the conduit for receiving a syringe body inserted into the handle portion. A syringe nozzle receiving portion may be continuous with the syringe body receiving portion for receiving a nozzle of a syringe inserted into the handle portion.

In one aspect, the applicator may be formed by additive manufacturing. The valve seat bore may be for receiving a valve seat.

In one aspect, there is provided an applicator positionable within a valve seat bore of an engine. The applicator includes a first body portion. A first sealing portion extends radially outwardly from the first body portion for sealing abutment with the valve seat bore. A first wiper portion extends radially outwardly from the first body portion and narrower in diameter than the first sealing portion. A first circumferential groove is between the first sealing portion and the first wiper portion and is recessed relative to the first wiper portion. A first seat extends radially inwardly from the first wiper portion for receiving a first ledge within the valve seat bore in sealing cooperation therein. A second body portion extends axially away from the first wiper portion, the second body portion having a reduced-diameter end portion opposite the first wiper portion for sealing cooperation with a second ledge within the valve seat bore. A second wiper portion extends radially outwardly from the second body portion and narrower in diameter than the second sealing portion. A second circumferential groove is between the second sealing portion and the second wiper portion and is recessed relative to the second wiper portion. A conduit extends continuously through the first body portion, the first circumferential groove and the second body portion to the second circumferential groove. A second seat extends radially inwardly from the second wiper portion for sealing cooperation with the valve seat bore. At least one first outlet extends from the conduit to the first circumferential groove. At least one second outlet extends from the conduit to the second circumferential groove.

### BRIEF DESCRIPTION OF THE DRAWINGS

Exemplary non-limiting embodiments are described with reference to the accompanying drawings in which:

FIG. 1 is a perspective view of an applicator according to the present invention;

FIG. 2 is an elevation view of the applicator of FIG. 1;

FIG. 3 is a cross section illustration of the applicator of FIG. 1 within a valve seat bore;

FIG. 4 is a cross section view of the applicator of FIG. 1; and,

FIG. 5 is a top-down view of the applicator of FIG. 1.

### DETAILED DESCRIPTION

The present disclosure generally relates to application of semi-fluid materials to surfaces and particularly to application of sealant to inner surfaces of a valve seat bore prior to installation of valve seats in an engine.

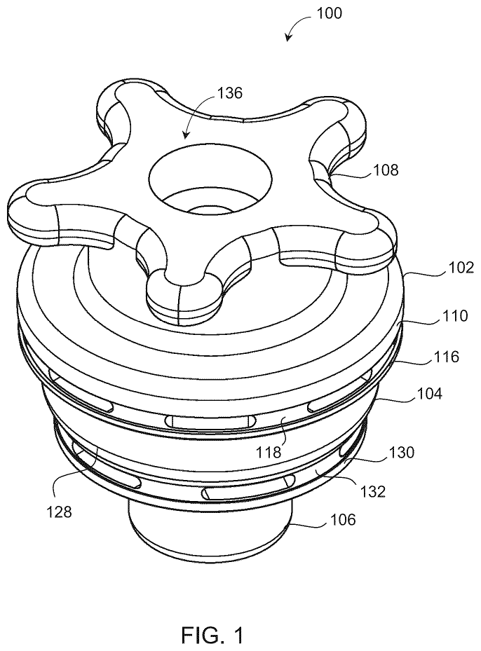

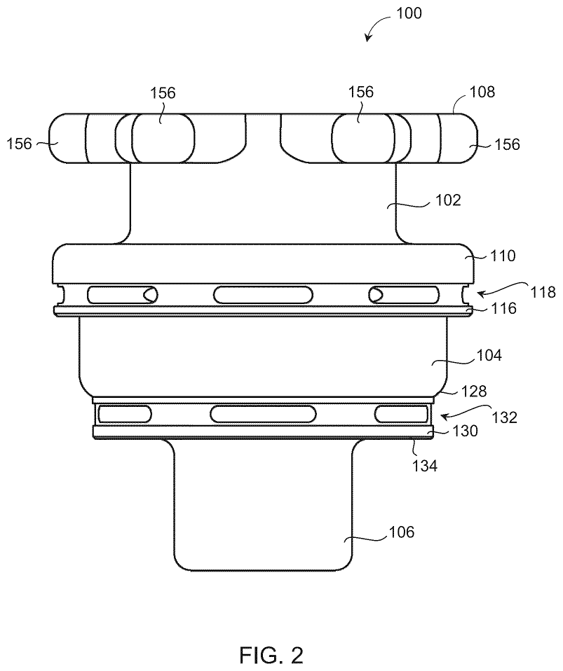

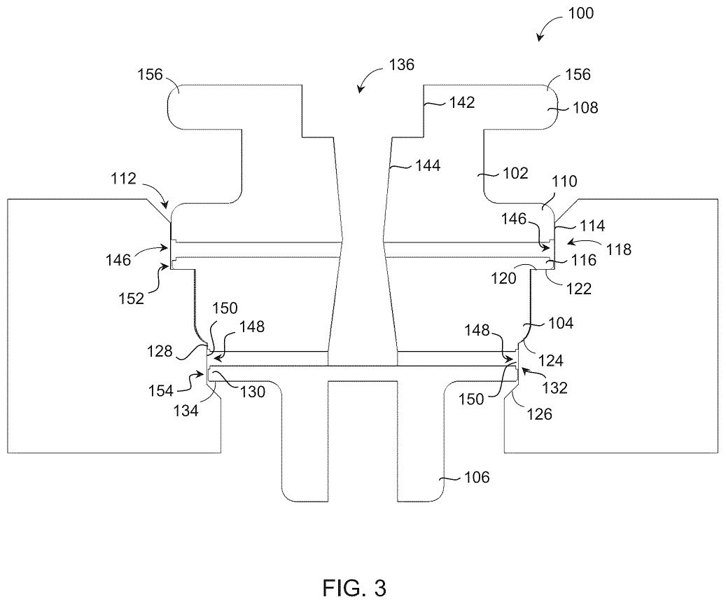

With reference to FIGS. 1 and 2, there is shown an applicator 100 positionable within a bore such as a valve seat bore 112 (FIG. 3) of a combustion engine for application of a semi-fluid material such as a sealant within the valve seat bore. Typically, valve seat bores are machined and are typically circular in cross section. Valve seat bores may narrow in diameter along a length thereof, often in a step-wise manner, defining shoulders, angled wall portions and ledges therein spaced apart by straight or cylindrical wall portions. Preferably, applicator 100 is machined to have dimensions which fit within the bore. Applicator 100 is removable from the bore once sealant has been applied. Preferably, applicator 100 is a unitary article formed by additive manufacturing. However, applicator 100 may also be modular, with components couplable with one another for providing the applicator 100 as substantially described herein. Applicator 100 includes a first body portion 102, a second body portion 104 and a base portion 106. A handle portion 108 extends from the first body portion 102 upwardly, or axially away from second body portion 104.

With further reference to FIG. 3, extending radially outwardly from first body portion 102 is a first sealing portion 110. First sealing portion 110 is sized or dimensioned such that when applicator 100 is inserted into the bore 112, first sealing portion 110 snugly fits within bore 112 and sealingly abuts a first bore wall portion 114. As will be described further below, sealing abutment between first sealing portion 110 and first bore wall portion 114 prevents flow of sealant therebetween.

A first wiper portion 116 is axially spaced apart from a first sealing portion 110 by a first circumferential groove 118 extending between first sealing portion 110 and first wiper portion 116. Preferably, first circumferential groove 118 is slightly recessed relative to first wiper portion 116. First wiper portion 116 extends radially outwardly from first body portion 102. Extending radially inwardly from first wiper portion 116 is a first seat 120. As shown in FIG. 3, bore 112 narrows along a length thereof in a step-wise manner. In the aspect illustrated in FIG. 3, bore 112 includes a first reduced-diameter wall portion 122, a second reduced-diameter wall portion 124 and a third reduced-diameter wall portion 126. Preferably, first reduced-diameter wall portion is a first ledge 122, second reduced-diameter wall portion is a second ledge 124 and third reduced-diameter wall portion is a third ledge 126. Preferably, first ledge 122, second ledge 124 and third ledge 126 are progressively narrower in diameter. It should be understood that bore 112 may include as many ledges, constrictions or narrowing sections as is required for the engine from which it is formed to function. First seat 120 receives the first ledge 122 and engages first ledge 122 in sealing abutment therewith. Sealing abutment between first seat 120 and first ledge 122 prevents flow of sealant therebetween, as will be further described hereinafter.

Second body portion 104 extends from first wiper portion 116 axially away from first body portion 102. Second body portion 104 has a reduced-diameter end portion 128 opposite first wiper portion 116 for sealing cooperation with second ledge 124. As will be described further below, sealing abutment between reduced-diameter end portion 128 and second ledge 124 prevents flow of sealant therebetween.

A second wiper portion 130 is axially spaced apart from reduced-diameter end portion 128 by a second circumferential groove 132 extending therebetween. Preferably, second wiper portion 130 is slightly recessed from second wiper portion 130. Second wiper portion 130 extends radially outwardly from second body portion 104. Extending radially inwardly from second wiper portion 130 is a second seat 134. Second seat 134 receives third ledge 126 and engages third ledge 126 in sealing cooperation therewith. Sealing abutment between second seat 134 and third ledge 126 prevents flow of sealant therebetween, as will be further described hereinafter. Applicator 100 further includes base portion 106 which extends from the second seat 134 axially away from first body portion 102.

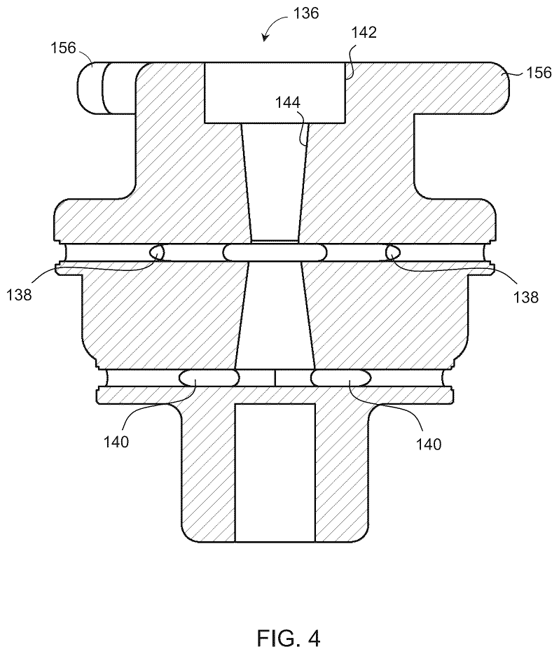

As shown in FIGS. 1, 3 and 4, a conduit 136 extends continuously through the first body potion, through second body portion 104, the first circumferential groove 118 and the second body portion 104 to the second circumferential groove 132. Preferably, conduit 136 extends along a longitudinal axis of the applicator 100. At least one first outlet 138 extends from the conduit 136 to the first circumferential groove 118. In one preferred aspect, the at least one first outlet 138 includes a plurality of first outlets 138. At least one second outlet 140 extends from conduit 136 to the second circumferential groove 132. In one preferred aspect, the at least one second outlet 140 includes a plurality of second outlets 140. First outlets 138 and second outlets 140 permit flow of sealant from conduit 136 to first circumferential groove 118 and second circumferential groove 132, respectively.

The conduit 136 receives sealant from a sealant syringe (not shown). The syringe containing the sealant may include a syringe body (not shown) for containing a supply of sealant and a syringe nozzle (not shown) for discharging sealant therefrom. Sealant may be discharged by means of a plunger extending into the syringe body and operable by a user by means of applied pressure. In a preferred aspect, conduit 136 extends through handle portion 108 and the conduit 136 further includes a syringe body receiving portion 142 and a syringe nozzle receiving portion 144.

As sealant is discharged into conduit 136, sealant will flow along conduit 136, into first circumferential groove 118 via first outlets 138 and into second circumferential groove 132 via second outlets 140. Discharge of sealant into conduit 136 may take place once applicator 100 is positioned within bore 112. However, it is preferable to first load applicator 100 with sealant from the syringe prior to insertion of applicator 100 into bore 112 by discharging a sufficient amount of sealant into conduit 136 such that the sealant enters first circumferential groove 118 and second circumferential groove 132 without overflow. Then, applicator 100 is inserted into bore 112 and further sealant is discharged in order to deposit sealant onto walls of bore 112 adjacent first circumferential groove 118 and second circumferential groove 132.

As described above, first sealing portion 110 is in sealing abutment with first bore wall portion 114 and first seat 120 is in sealing cooperation with first ledge 122. Once applicator 100 is positioned within bore 112, there is defined a first sealant-receiving cavity 146 between the first bore wall portion 114, the first sealing portion 110 and the first seat 120 which extends circumferentially about the first circumferential groove 118, as shown in FIG. 3. Overflow of sealant beyond the first sealant-receiving cavity 146 is prevented by the sealing abutment between the first sealing portion 110 and the first bore wall portion 114 and the first seat 120 and first ledge 122.

Likewise, reduced-diameter end portion 128 is in sealing abutment with second ledge 124 and second seat 134 is in sealing cooperation with third ledge 126. Once applicator 100 is positioned within bore 112, there is defined a second sealant-receiving cavity 148 between a second bore wall portion 150 adjacent to the second circumferential groove 132, the reduced-diameter end portion 128 and the second seat 134 which extends circumferentially about the second circumferential groove 132, as shown in FIG. 3. Overflow of sealant beyond the second sealant-receiving cavity 148 is prevented by the sealing abutment between the reduced-diameter end portion 128 and the second bore wall portion 150 and the second seat 134 and the third ledge 126.

Accordingly, a user applying sealant to the first bore wall portion 114 and the second bore wall portion 150 may do so without causing undesirable overflow of sealant to areas of bore 112 where sealant is not required or where sealant is not desired. This prevents unwanted loss of materials and prevents unwanted loss of worker time on unnecessary cleanup.

Further advantage is provided whereby applicator 100, once loaded, may be moved from one bore to the next for application of sealant to other bores 112. Moreover, if a syringe is exhausted, it may be switched with a fresh syringe having a fresh supply of sealant without having to load the applicator 100 again. This permits a worker to apply sealant to a greater number of bores in a lesser period of time as compared to conventional methods.

As further shown in FIG. 3, first wiper portion 116 is slightly narrower in diameter than first sealing portion 110. Accordingly, there is provided a first gap 152 between first wiper portion 116 and first bore wall portion 114 which, in one preferred aspect, is 15/1000 inches across. After sealant is applied to the first bore wall portion 114, applicator 100 is withdrawn from bore 112. As applicator 100 is withdrawn, first wiper portion 116 leaves a thin film of sealant on first bore wall portion 114 while pulling out or wiping away excess sealant material. Likewise, second wiper portion 130 is slightly narrower in diameter than reduced-diameter end portion 128. Accordingly, there is provided a second gap 154 between second wiper portion 130 and second bore wall portion 150 which, in one preferred aspect is 15/1000 inches across. As applicator 100 is withdrawn from bore 112, second wiper portion 130 leaves a thin film of sealant on second bore wall portion 150 while pulling out or wiping away excess sealant material.

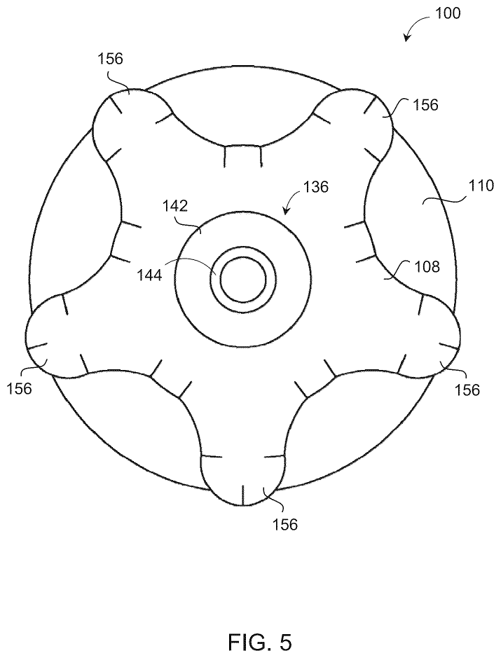

In one preferred aspect, applicator 100 may be rotated or turned within bore 112 prior to withdrawal of the applicator 100 from bore 112. Turning of the applicator 100 ensures even distribution of the sealant along first bore wall portion 114 and second bore wall portion 150. In a preferred aspect, handle portion 108 has extending therefrom a plurality of petaloid projections 156, as shown in FIG. 5. Petaloid projections 156 provide a grip for the hands and fingers of a user for application of torque to the applicator 100.

While the invention has been described in terms of specific embodiments, it is apparent that other forms could be adopted by one skilled in the art. For example, the methods described herein could be performed in a manner which differs from the embodiments described herein. The steps of each method could be performed using similar steps or steps producing the same result but which are not necessarily equivalent to the steps described herein. Some steps may also be performed in different order to obtain the same result. Similarly, the apparatuses and systems described herein could differ in appearance and construction from the embodiments described herein, the functions of each component of the apparatus could be performed by components of different construction but capable of a similar though not necessarily equivalent function, and appropriate materials could be substituted for those noted. Accordingly, it should be understood that the invention is not limited to the specific embodiments described herein. It should also be understood that the phraseology and terminology employed above are for the purpose of disclosing the illustrated embodiments, and do not necessarily serve as limitations to the scope of the invention.

What is claimed is:

1. An applicator positionable within a valve seat bore of an engine, the applicator comprising:
a body portion;
a sealing portion extending radially outwardly from the body portion for sealing abutment with the valve seat bore;
a wiper portion extending radially outwardly from the body portion and narrower in diameter than the sealing portion;
a circumferential groove between the sealing portion and the wiper portion and recessed relative to the wiper portion;
a seat extending radially inwardly from the wiper portion for sealing cooperation with a first reduced-diameter wall portion of the valve seat bore;
a conduit extending through the body portion and the sealing portion to the circumferential groove; and,
at least one outlet extending from the conduit to the circumferential groove.

2. The applicator of claim 1, further comprising:
a second body portion extending axially away from the wiper portion, the second body portion having a reduced-diameter end portion opposite the wiper portion for sealing cooperation with a second reduced-diameter wall portion of the valve seat bore;
a second wiper portion extending radially outwardly from the second body portion and narrower in diameter than the second sealing portion;
a second circumferential groove between the second sealing portion and the second wiper portion and recessed relative to the second wiper portion, wherein the conduit extends continuously through the body portion, the circumferential groove and the second body portion to the second circumferential groove;
a second seat extending radially inwardly from the second wiper portion for sealing cooperation with the valve seat bore; and,
at least one second outlet extending from the conduit to the second circumferential groove.

3. The applicator of claim 1, wherein a sealant-receiving cavity extending circumferentially about the circumferential groove is defined between the sealing portion, the seat and a wall of the valve seat bore when the applicator is positioned within the valve seat bore.

4. The applicator of claim 2, wherein a sealant-receiving cavity extends circumferentially about the second circumferential groove is defined between the second sealing portion, the second seat and a wall of the valve seat bore when the applicator is positioned within the valve seat bore.

5. The applicator of claim 1, wherein the first reduced-diameter wall portion of the bore is a first ledge which is received by the seat when the applicator is positioned within the valve seat bore.

6. The applicator of claim 2, wherein the first reduced-diameter wall portion of the valve seat bore is a first ledge which is received by the seat and the second reduced-diameter wall portion of the valve seat bore is a second ledge narrower than the first ledge which cooperates in sealing abutment with the reduced-diameter end portion of the second body portion when the applicator is positioned within the valve seat bore.

7. The applicator of claim 1 further comprising:
a handle portion extending from the body portion.

8. The applicator of claim 7 wherein the conduit extends through the handle portion.

9. The applicator of claim 8 further comprising:
a syringe body receiving portion continuous with the conduit for receiving a syringe body inserted into the handle portion.

10. The applicator of claim 9, further comprising:
a syringe nozzle receiving portion continuous with the syringe body receiving portion for receiving a nozzle of a syringe inserted into the handle portion.

11. The applicator of claim 7, further comprising:
a plurality of petaloid projections extending radially outwardly from the handle portion.

12. The applicator of claim 2, further comprising:
a base portion extending axially away from the second seat for being received in sealing cooperation within the bore when the applicator is positioned within the valve seat bore.

13. The applicator of claim 1, wherein the conduit extends along a longitudinal axis of the body portion.

14. The applicator of claim 1, wherein the at least one outlet includes a plurality of outlets.

15. The applicator of claim 2, wherein the at least one outlet includes a plurality of outlets and the at least one second outlet includes a plurality of second outlets.

16. The applicator of claim 2, wherein the second body portion is receivable within the bore in sealing cooperation therewith.

17. The applicator of claim 1, formed by additive manufacturing.

18. The applicator of claim 1, wherein the valve seat bore is for receiving a valve seat.

19. An applicator positionable within a valve seat bore of an engine, the applicator comprising:
a first body portion;
a first sealing portion extending radially outwardly from the first body portion for sealing abutment with the valve seat bore;
a first wiper portion extending radially outwardly from the first body portion and narrower in diameter than the first sealing portion;
a first circumferential groove between the first sealing portion and the first wiper portion and recessed relative to the first wiper portion;
a first seat extending radially inwardly from the first wiper portion for receiving a first ledge within the valve seat bore in sealing cooperation therein;
a second body portion extending axially away from the first wiper portion, the second body portion having a reduced-diameter end portion opposite the first wiper portion for sealing cooperation with a second ledge within the valve seat bore;
a second wiper portion extending radially outwardly from the second body portion and narrower in diameter than the second sealing portion;
a second circumferential groove between the second sealing portion and the second wiper portion and recessed relative to the second wiper portion;
a conduit extending continuously through the first body portion, the first circumferential groove and the second body portion to the second circumferential groove;
a second seat extending radially inwardly from the second wiper portion for sealing cooperation with the valve seat bore;
at least one first outlet extending from the conduit to the first circumferential groove; and,
at least one second outlet extending from the conduit to the second circumferential groove.
